(19) United States
(12) Patent Application Publication
(10) Pub. No.: US 2016/0186651 A1
(43) Pub. Date: Jun. 30, 2016

(54) INDUCTION MODULE FOR AN INTERNAL COMBUSTION ENGINE

(71) Applicant: MAHLE INTERNATIONAL GMBH, Stuttgart (DE)

(72) Inventors: Simon ELFLEIN, Karlsruhe (DE); Sascha NAUJOKS, Pfinztal (DE); Simon SCHNEIDER, Stuttgart (DE)

(21) Appl. No.: 14/909,459

(22) PCT Filed: Jul. 24, 2014
(86) PCT No.: PCT/EP2014/065970

§ 371 Date: Feb. 1, 2016

(30) Foreign Application Priority Data
Aug. 2, 2013 (DE) 10 2013 215 234.5

(51) Int. Cl. F02B 29/04; F02M 26/19; F02M 35/10

(52) U.S. Cl. CPC F02B 29/0475; F02M 35/10222; F02M 26/19; F02M 35/10052; F02M 35/10268; F02M 35/10327

(57) ABSTRACT

An induction module with integrated exhaust gas recirculation may include a housing defining a housing interior and having a first housing wall with at least one air inlet for conducting fresh air into the housing interior and a second housing wall with at least one fluid outlet. A charge-air cooler may be arranged in the housing interior. A mixing chamber may define at least part of the housing interior and may be delimited by the charge-air cooler and the second housing wall. An exhaust line may be arranged in the mixing chamber having at least one exhaust gas outlet that may be in fluid communication with the mixing chamber. The charge-air cooler and the exhaust line may be arranged in the housing such that the exhaust gas communicated into the mixing chamber may bypass the charge-air cooler.

### CROSS-REFERENCE TO RELATED APPLICATIONS

This application claims priority to German Patent Application No. 10 2013 215 234.5, filed Aug. 2, 2013, and International Patent Application No. PCT/EP2014/065970, filed Jul. 24, 2014, both of which are hereby incorporated by reference in their entirety.

### TECHNICAL FIELD

The present invention relates to an induction module for an internal combustion engine.

### BACKGROUND

Induction modules for internal combustion engines serve for the induction and introduction of air from the environment into the combustion chamber of the internal combustion engine. Basically, one or more functional elements of the induction tract of the internal combustion engine can be integrated into such induction modules, in order to allow for the fact that installation space is only available to a limited extent in a motor vehicle. Concepts are known, in which a so-called exhaust gas recirculation is integrated into the said induction module. Generally, the exhaust gas recirculation serves for the reduction of the pollutants emitted by the internal combustion engine into the environment during normal operation and is based on the idea of mixing a portion of the exhaust gas generated during the combustion process with the fresh air inducted by the induction module and introducing it again into the combustion chamber. Such exhaust gas recirculation systems are embodied for instance in connection with an exhaust gas turbocharger. The prior art comprises for example so-called high pressure or low pressure recirculation systems, according to the location in the induction- or respectively exhaust gas tract of the internal combustion engine at which the exhaust gas recirculation takes place.

A problem in such exhaust gas recirculation systems is the only limited available installation space in the motor vehicle, which conflicts with an optimum mixing of the recirculated exhaust gas with inducted fresh air. Known concepts provide a distribution of the entire exhaust gas which is to be recirculated to several fresh air inlets, in which then the desired mixing of exhaust gas with fresh air takes place partially respectively. However, in such systems the complexity of the line connections in the recirculation tract increases considerably.

EP 1 122 421 A2 describes an intake manifold with integrated exhaust gas recirculation system for an internal combustion engine. The intake manifold comprises a collecting space for fresh air inducted from the environment. An exhaust line opens into the collecting space, which exhaust line is flowed through by exhaust gas which is to be recirculated. The collecting space has an air inlet which forms an angle of substantially 90° with the corresponding openings in the exhaust line.

From DE 103 54 129 A1 a suction system is known for an internal combustion engine with a fresh gas distributor. The fresh gas distributor comprises a plurality of fresh gas outlets, wherein each such fresh gas outlet is associated with a particular cylinder of the internal combustion engine. Adjacent to the fresh air distributor, a distributor duct of an exhaust gas recirculation is provided, which communicates fluidically with the fresh air distributor.

U.S. Pat. No. 5,957,116 describes the exhaust gas recirculation system for an internal combustion engine. The exhaust gas recirculation system comprises an exhaust line with a plurality of exhaust gas outlet openings, which are provided in a circumferential wall of the exhaust line. The exhaust line extends within an induction line for fresh air; the induction line and exhaust line extend substantially parallel to one another.

EP 911 946 A2 concerns an induction module with integrated exhaust gas recirculation. The induction module comprises a housing delimiting a housing interior, which has a first housing wall with at least one air inlet for the conducting in of fresh air into the housing interior, and a second housing wall with at least one fluid outlet. A charge-air cooler is arranged in the housing interior. The induction module further comprises a mixing chamber, which is part of the housing interior.

The induction module has furthermore an exhaust line, which is arranged in the housing. The exhaust line has a plurality of exhaust gas outlets communicating fluidically with the mixing chamber, by means of which an exhaust gas, flowing through the exhaust line, is able to be introduced into the mixing chamber.

FR 2 781 530 A1 concerns a centrifugal turbine for a vehicle air conditioning system.

FR 2,946,699 A1 describes an induction module with a mixing device for the mixing of recirculated exhaust gas of an internal combustion engine with charge air pre-cooled by a charge-air cooler.

DE 198 11 634 A1 discloses an air induction duct for a diesel engine with integrated exhaust gas recirculation duct.

The relatively high temperature of the exhaust gas which is to be recirculated, which generally brings about a reduction of the air mass flow able to be introduced into the internal combustion engine and therefore is counterproductive with regard to the efficiency able to be achieved with the internal combustion engine, proves to be a problem in the return of exhaust gas into the combustion chamber of the internal combustion engine. Known concepts are therefore aimed at a cooling of the exhaust gas mixed with fresh air in the induction tract through thermal interaction with a cooling medium.

Devices suitable for this are known as so-called charge-air coolers. Through the cooling of the fresh air charged with exhaust gas in connection with supercharged internal combustion engines and known as “charge air”—contaminations of components exposed to the fluid flow and of the charge-air cooler occur, however, which in the worst case leads to a partial “clogging” of the charge-air cooler. Also, the exhaust gas, if it comes in contact with moisture, can form an aggressive acid which attacks the charge-air cooler or other components. As moisture is contained both in the exhaust gas and also in the fresh air, which moisture is precipitated on cooling below the dew point, great corrosion problems also exist at various locations.

### SUMMARY

The main object of the present invention is therefore the provision of an improved induction module with integrated exhaust gas recirculation, in which the above-mentioned problems no longer occur or only occur to a reduced extent.

This problem is solved by the subject of the independent claims. Preferred embodiments are the subject of the dependent claims.

The basic idea of the invention is accordingly to mix fresh or respectively charge air, introduced into an induction module, with exhaust gas only after cooling in a charge-air cooler. Therefore, a contamination and damage to the charge-air cooler or respectively the other components can be prevented.

The mixing of the fresh or respectively charge air with the exhaust gas takes place here according to the invention in a mixing chamber which is constructed between a fresh air outlet of the charge-air cooler and a housing wall of the housing of the induction module. Said housing wall of the housing has at least one outlet, preferably several outlets, which lead to cylinders of an internal combustion engine. This permits, in the most cramped installation space, a pronounced and homogeneous mixing of the exhaust gas with the fresh air in the mixing chamber. Subsequently, the fresh air, mixed with exhaust gas, can be distributed homogeneously to the different cylinders of the internal combustion engine, which improves the efficiency thereof to a not insignificant extent.

An induction module according to the invention comprises a housing delimiting a housing interior, which has a first housing wall with at least one air inlet and a second housing wall with at least one fluid outlet. A charge-air cooler is arranged in the housing interior. The induction module has, in addition, a mixing chamber which is part of the housing interior and is delimited by the charge-air cooler and the second housing wall. An exhaust line is arranged in the mixing chamber, in which exhaust line at least one exhaust gas outlet is provided, communicating fluidically with the mixing chamber. This exhaust gas outlet is provided on a side of the exhaust line facing toward the air inlet and therefore toward the charge-air cooler. By means of the exhaust gas outlet, the exhaust gas flowing through the exhaust line can be introduced into the mixing chamber.

The distance between the exhaust line and the charge-air cooler is selected such that the outflowing exhaust gas still flows against the charge-air cooler, but does not penetrate into the charge-air cooler. Therefore the exhaust gas which is conducted in covers the distance between exhaust line and charge-air cooler twice, wherein the exhaust gas, on flowing towards the charge-air flow already mixes with the latter, and the mixing progresses on the flowing back up to the exhaust line. In the region after the exhaust line, the exhaust gas continues to mix with the charge air, whereby a very homogeneous mixing is achieved, before the gas mixture enters into the outlets leading to the individual cylinders. As a result, a contamination of the charge-air cooler is prevented and a maximum mixing section is formed, which leads to a particularly homogeneous mixing of the gases.

In a preferred embodiment, the flow direction of the exhaust gas which is introduced into the mixing chamber runs opposed to the flow direction of the fresh air which is introduced into the mixing chamber. Consequently, the two directions form an angle of substantially 180° to one another. “Substantially” is to be understood here to mean an angle interval of 160° to 200, preferably of 170° to 190°. A particularly good mixing of the fresh air with exhaust gas is achieved when air- and exhaust gas molecules meet one another at an angle of as precisely as possible 180°, because in this case the air- or respectively exhaust gas molecules, on meeting one another, have a impulse opposed to one another, which promotes their mixing particularly intensely.

According to a particular configuration of the invention, the distance between the exhaust line and the charge-air cooler corresponds substantially to the distance of the exhaust line to the second housing wall, in which the fluid outlets to the cylinders are arranged. Through such a configuration, the mixing length in the mixing chamber can be extended.

In other embodiments, the distance from the exhaust line to the charge-air cooler can, however, also be greater or smaller than the distance between the exhaust line and said second housing wall. Depending on the design, such a multiplication, e.g. doubling or tripling, of the mixing length can be achieved.

In particular configurations, the distance between the exhaust line and the charge-air cooler is approximately 2-10 cm, preferably approximately 4-5 cm.

The realization of the charge-air cooler in the form of a coolant tube is particularly simple for the specialist in terms of production. Such a coolant tube can have respectively a coolant inlet or respectively coolant outlet on the face side. Alternative charge-air coolers can be constructed as tube bundle coolers or rib-tube coolers with a cooler housing, in which respectively at least one coolant path is provided. A charge-air cooler realized in such a manner can have on a face-side housing wall of its cooler housing a coolant inlet and a coolant outlet and can be arranged with respect to the coolant path substantially parallel to the exhaust line in the housing interior. In this way, a particularly uniform mixing of fresh air and exhaust gas occurs in the mixing chamber.

Particularly expediently, the charge-air cooler can comprise a cooler housing made of metal. Alternatively or additionally, the housing of the induction can be made from a plastic.

In another preferred embodiment, the cooler housing can have a housing wall facing toward the exhaust line, in which at least one charge air outlet is provided for conducting the fresh air, cooled in the charge-air cooler, into the mixing chamber. In this way, a particularly homogeneous mixing of the fresh- or respectively charge air leaving the charge-air cooler with the exhaust gas conducted from the exhaust line into the mixing chamber can be achieved.

In the production of the induction module, the charge-air cooler and/or the exhaust line can be formed particularly expediently integrally on the housing of the induction module. Hereby, a laborious pre-mounting of the two components on the housing is dispensed with, which reduces the manufacturing costs of the induction module to a not insignificant extent. However, it is also conceivable to provide an aperture at a suitable location in the housing, through which the charge-air cooler can be inserted detachably into the housing.

In view of its high rigidity, a realization of the exhaust line in the form of an exhaust pipe represents a particularly advantageous structural form. Of course, however, other suitable forms, deviating from such a tube form, also present themselves. The exhaust line in the form of an exhaust pipe which is equipped with a circumferential wall in which again the at least one exhaust gas outlet is provided is able to be realized particularly simply from production-oriented considerations.

For the purpose of installation space optimization, it is recommended to arrange the exhaust line for instance substantially transversely to an air flow direction, along which the fresh- or respectively charge air which is to be mixed with exhaust gas flows into the mixing chamber.

An embodiment in which the housing is provided with an aperture through which the exhaust line is guided from the exterior into the mixing chamber proves to be particularly advantageous from a production-oriented point of view.

Providing the guiding of the exhaust line through the housing in a housing region laterally to the first and second housing wall presents itself particularly expediently.

Preferably, not only a single fluid outlet is provided on the housing, but rather a plurality of fluid outlets, which corresponds to a number of cylinders of an internal combustion engine using the induction module, so that each fluid outlet is associated with a particular cylinder. In a variant, precisely two fluid outlets are associated with each cylinder, i.e. the number of fluid outlets is twice the number of cylinders.

Various structural options also present themselves to the specialist for the configuration of the exhaust gas outlet. Thus, in the simplest form, this can comprise at least one exhaust gas outlet opening. A variant is to be preferred having four such exhaust gas outlet openings, which are to be arranged at a distance along the exhaust line, in order to ensure a particularly uniform conduction of exhaust gas into the mixing chamber compared to the option with only one exhaust gas outlet opening. Preferably, the number of exhaust gas outlet openings is twice, particularly preferably a multiple or more of a cylinder number of the internal combustion engine using the induction module.

In order to further improve the mixing of fresh air and exhaust gas in the scenarios described above, the arranging of at least one deflection element in the mixing chamber is recommended, and namely with respect to the flow direction of the fresh air between charge-air cooler and exhaust line. The placing of such a deflection element, for example in the manner of a shield, should take place such that it deflects at least a portion of the fresh air which is introduced into the mixing chamber before it meets the exhaust gas which is introduced into the mixing chamber. With regard to the mixing process, particularly good results can be achieved when the deflection element also brings about a deflection of the exhaust gas before the latter meets the fresh air. It presents itself as particularly expedient to configure the deflection element so that it channels the fresh air which is conducted into the mixing chamber before said fresh air is mixed with exhaust gas.

In an advantageous further development, the air inlet and the exhaust gas outlet are facing toward one another in a cross-section of the mixing chamber. In this cross-section, the deflection element can have a geometry curved toward the air outlet, preferably in the manner of a segment of a circle, This brings about the desired channelling of the flow direction of the exhaust gas introduced into the mixing chamber, before it meets fresh air. In this scenario, fresh air and exhaust gas in fact have substantially opposite flow directions on conducting into the mixing chamber, but not at the actual meeting of exhaust gas- and fresh air molecules in the mixing chamber. The intrusive formation of eddy flows, which can undesirably reduce the air- or respectively exhaust gas mass throughput through the induction module, is in this way largely ruled out.

For the case where a plurality of exhaust gas outlet openings are provided in the exhaust line, it presents itself to provide an exhaust gas deflection element projecting inwardly into the exhaust line in the exhaust gas outlet opening, which exhaust gas deflection element can serve for the at least partial deflection of the exhaust gas flowing through the exhaust line. Such an exhaust gas deflection element is able to assist the conducting out of a fraction of the exhaust gas flowing through the exhaust line. Therefore, a little effective accumulating of the exhaust gas at the end of the exhaust line is largely or even completely prevented. Instead, in an advantageous manner, an approximately even mass throughput through the individual exhaust gas outlet openings is achieved.

According to an advantageous embodiment, the exhaust gas deflection element forms in the cross-section of the mixing chamber with a circumferential wall of the exhaust line an angle of substantially 135°. It is clear that the specialist can also realize other angles through uncomplicated structural alterations. The exhaust gas deflection elements act in each case as a type of guide for the conducting out of exhaust gas of the exhaust line via the exhaust gas outlet opening associated with the respective deflection element.

Exhaust gas outlet openings which have for instance a round, in particular circular, an elliptical, a polygonal, preferably a rectangular, most preferably a square, opening contour or a combination of these contours, in particular a combination of a rectangle and a semicircle, are able to be realized technically particularly simply.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown, respectively diagrammatically

FIG. 1a an example of an induction module according to the invention,

FIG. 1b an alternative example of the induction module according to FIG. 1a,

FIG. 2 a variant of the example of FIGS. 1a and 1b with a deflection element for the deflecting of exhaust gas introduced into the mixing chamber,

FIGS. 3a and 3b represent a further variant of the example of FIGS. 1a, 1b and 2 with deflection elements for the deflecting of the exhaust gas flowing through the exhaust line,

FIGS. 4a, 4b and 4c represent illustrative examples for a possible geometric shape of an exhaust gas outlet opening.

### DETAILED DESCRIPTION

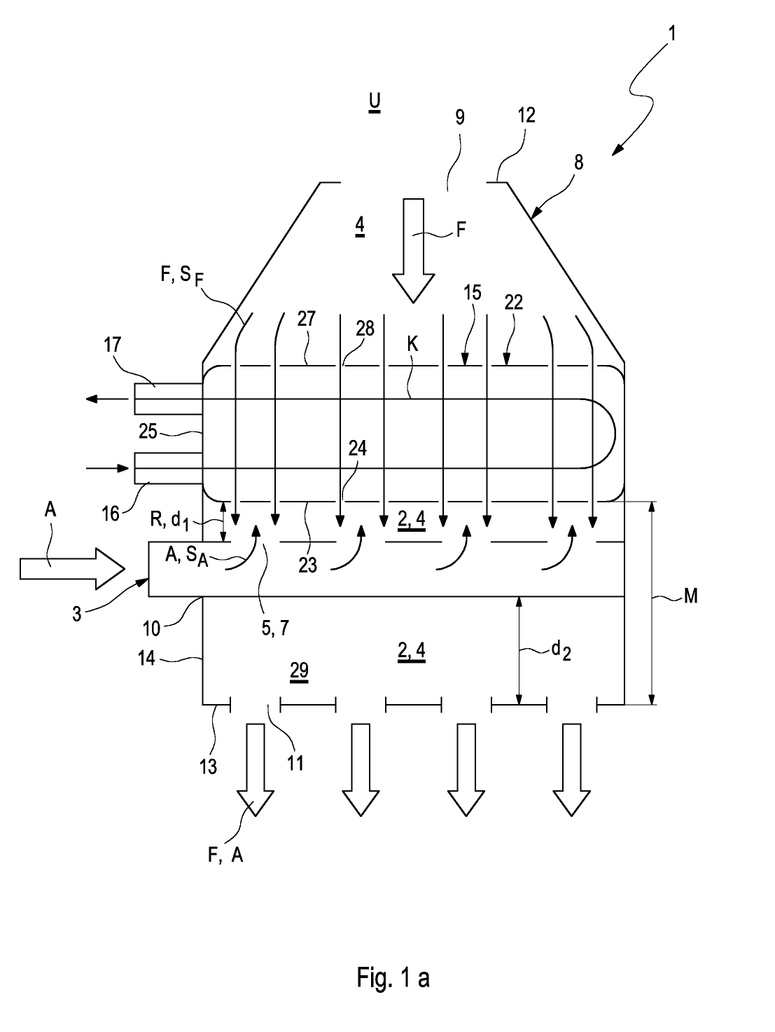

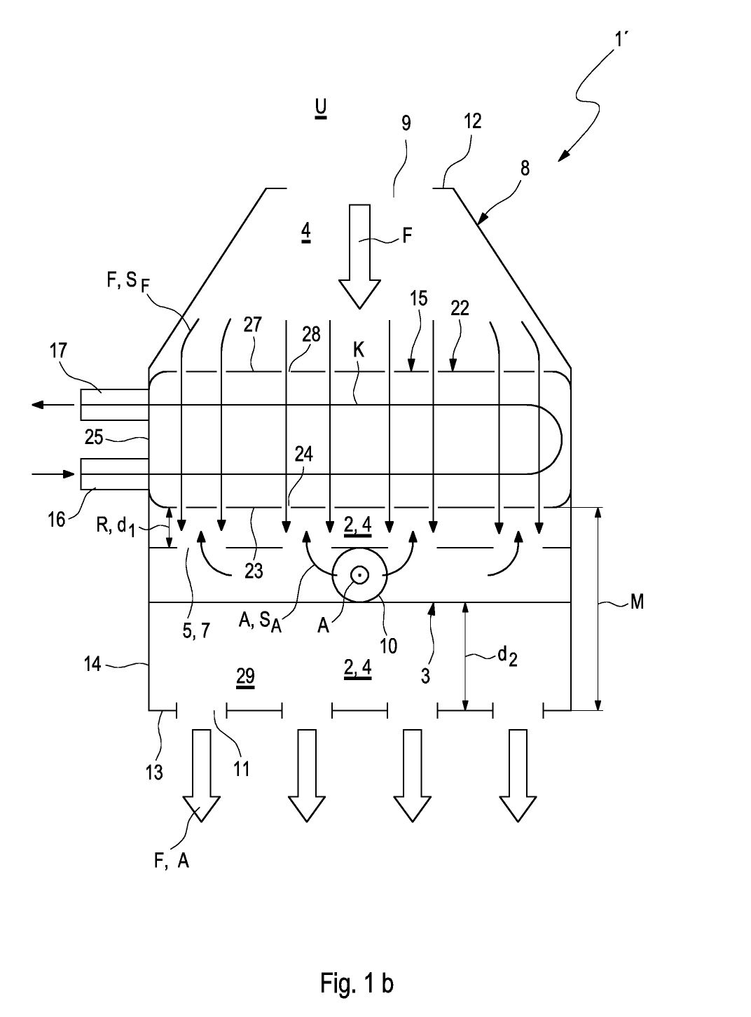

FIG. 1a illustrates in a diagrammatic illustration an example of an induction module 1 according to the invention with integrated exhaust gas recirculation. The induction module 1 comprises a housing 8 of a plastic, delimiting a housing interior 4. The housing 8 comprises a first housing wall 12 with at least one air inlet 9 and a second housing wall 13 with at least one fluid outlet 11. Charge air or respectively fresh air F charged by an exhaust gas turbocharger can enter via the air inlet 9 into the housing interior 4. In the housing interior 4 a charge-air cooler 15 is arranged, which is flowed through by the fresh air F which is conducted into the housing interior 4. In this way, the fresh air F—this is typically hot charge air compressed by an exhaust gas turbocharger—is cooled by the charge-air cooler 15.

The induction module 1 has, in addition, a mixing chamber 2, which is part of the housing interior 4 and is delimited by the charge-air cooler 15 and the second housing wall 13. In the mixing chamber 2 an exhaust line 3 is arranged, in which at least one exhaust gas outlet 7 is provided, via which the exhaust line 3 communicates fluidically with the mixing chamber 2. Owing to its high rigidity, a realization of the exhaust line 3 in the form of an exhaust pipe is recommended. Of course, however, deviating from such a tube form, other suitable structural forms also present themselves.

The exhaust gas outlet 7 is provided on a side of the exhaust line 3 facing toward the air inlet 9. Via the exhaust gas outlet 7 an exhaust gas A, flowing through the exhaust line 3, is conducted into the mixing chamber 2, where it is mixed with the fresh air F emerging from the charge-air cooler 15. The fresh air F mixed with the exhaust gas A leaves the mixing chamber 2 through the at least one fluid outlet 11.

Typically, not only a single fluid outlet 11 is provided on the housing 8. Rather, the number of fluid outlets 11 preferably corresponds to the number of cylinders of the internal combustion engine cooperating with the induction module 1, or is twice this number. The induction module 1 with four fluid outlets 11 shown by way of example in FIG. 1a is therefore designed for use with an internal combustion engine with four or with eight cylinders.

The realization of the charge-air cooler unit 15 in the form of a coolant tube proves to be particularly simple for the specialist from a production-oriented point of view. Such a coolant tube can have respectively a coolant inlet or respectively a coolant outlet on the face side. Technically more complex variants of the charge-air cooler 15, on the other hand, can be constructed as so-called tube bundle coolers or rib-tube coolers. Such a charge-air cooler 15 can have a coolant path K, which is sketched only roughly diagrammatically in FIG. 1a and is flowed through by a coolant for cooling the fresh air F flowing through the charge-air cooler 15. The charge-air cooler 15 can have a cooler housing 22 made from metal, which is surrounded entirely or partially by the housing 8. The cooler housing 22 can comprise a housing wall 23 facing toward the exhaust line 3, in which housing wall in the example of FIG. 1a by way of example eight charge-air outlets 24 are provided. After the flowing through of the charge-air cooler 15—for this, the fresh air F conducted into the housing interior 4 can enter into the charge-air cooler 15 through charge-air inlets 28, which are provided in a housing wall 27 of the cooler housing 22 lying opposite the housing wall 23—the fresh air F enters into the mixing chamber 2 via the charge-air outlets 24. The charge-air cooler 15 can be provided—with respect to the coolant path K on a face-side housing wall 25—outside the mixing chamber 2 with a coolant inlet 16 or respectively a coolant outlet 17 for the conducting in or respectively out of coolant into or respectively out from the charge-air cooler 15.

In order to achieve a particularly uniform mixing of the fresh air F with the exhaust gas A, it presents itself to arrange the charge-air cooler 15 with respect to the extent of the coolant path K substantially parallel to the exhaust line 3 in the housing interior 4.

According to FIG. 1a, the mixing chamber 2 according to the invention is constructed between the housing wall 23 of the charge-air cooler 15, having the charge-air outlets 24, and the second housing wall 13 of the housing 8 of the induction module 1, in which the fluid outlets 11 are arranged. Therefore, in the mixing chamber 2 a mixing section M is produced, within which the fresh air can mix with the exhaust gas A. Through the exhaust gas A, blown in by the counterflow principle, the exhaust gas A flows in the direction of the charge-air cooler 15, wherein the exhaust gas covers a return flow section R. Therefore, the mixing section M is extended by the length of the return flow section R, whereby an improved mixing of the gases F, A is achieved.

The cooled fresh air guided through the charge-air cooler 15 has a very uniform flow, directed in a straight line, at the outlet from the charge-air cooler 15, through flow guides (not shown) arranged in the charge-air cooler 15. The exhaust gas flow directed in the counterflow to the charge-air cooler 15 reaches the charge-air cooler 15 in an optimum design, without the exhaust gas A penetrating into the charge-air cooler 15. Therefore, an undesired contamination of the charge-air cooler 15 is prevented. Furthermore, the mixing section M, on which a mixing of the fresh air F with the exhaust gas A takes place, is enlarged, which leads to an improved mixing of the gases.

In the example of FIG. 1a a distance d₁ between the exhaust line 3 and the charge-air cooler 15 is selected such that the outflowing exhaust gas A still flows against the charge-air cooler 15, but no longer penetrates into the charge-air cooler 15. Therefore, the introduced exhaust gas A covers the distance section d₁ between exhaust gas outlet 7 and charge-air cooler 15 twice, wherein the exhaust gas A on flowing contrary to the charge-air flow already mixes therewith and the mixing progresses on flowing back up to the exhaust line 3. In the region 29 downstream of the exhaust line 3, the exhaust gas A continues to mix with the fresh air F, whereby a very homogeneous mixing is achieved before the gas mixture flows through the fluid outlets 11 leading to the individual cylinders. As a result, an undesired contamination of the charge-air cooler 15 is prevented and a maximum mixing section is formed with a homogeneous mixing of the gases.

In particular configurations, the distance d₁ between the exhaust line 3 and the charge-air cooler 15 is approximately 2-10 cm, preferably approximately 4-5 cm.

The conducting of the exhaust gas A into the mixing chamber 2 of the induction module 1 takes place with a flow direction S_{A} opposed to the flow direction S_{F} of the fresh air F, and namely via four exhaust gas outlet openings 5 arranged adjacent to one another in the exhaust line 3 in flow direction S_{A}. The air inlet 9 and the exhaust outlet 7 face toward one another in a cross-section of the mixing chamber 3. This permits an improved mixing of the exhaust gas A with fresh air F, compared with conventional induction modules, even in a most cramped installation space. Therefore, the fresh air F which is mixed in such a way with exhaust gas A can be introduced homogeneously into the internal combustion engine, which considerably improves its efficiency. For installation space optimization, the exhaust line 3 is arranged substantially transversely to a flow direction S_{F} of the fresh air F in the housing interior 4.

The housing 8 is provided with an aperture 10, through which the exhaust line 3 is guided from the exterior into the mixing chamber 2. Here, it presents itself to provide the aperture 10 through the housing 8 in a lateral region of the housing 8—in particular laterally to the first and second housing wall 12, 13. In cross-section of the mixing chamber 2, this can be a housing side wall 14, which connects the first with the second housing wall 12, 13. An alternative embodiment of the aperture 10 in an upper or lower region is presented below in FIG. 1b.

In order to achieve as pronounced a mixing as possible of fresh air F and exhaust gas A, it is recommended according to FIG. 1a to place the exhaust line 3 in the housing 8 such that the exhaust gas outlet openings 5 face toward the air inlet 9. Then, the exhaust gas A emerging from the exhaust line 3 flows as desired in a substantially opposite direction S_{A} to the fresh air F into the mixing chamber 3, which promotes a homogeneous mixing process of fresh air F and exhaust gas A.

As illustrated in FIG. 1a, the flow direction S_{A} can run opposed to the flow direction S_{F}. This is because a good mixing of fresh air F with exhaust gas A is precisely achieved when air- and exhaust gas molecules meet one another at an angle of as precisely as possible 180°. In this case, the two directions S_{A}, S_{F} form an angle of 180° to one another. Other preferred angle values for the angle between the flow directions S_{A}, S_{F} can be defined by an angle interval of 160° to 200 or of 170° to 190°.

Preferably, the distance d₁ between the exhaust line 3 and the charge-air cooler 15 corresponds to a distance d₂ of the exhaust line 3 to the second housing wall 13, in which the fluid outlets 11 to the cylinders are arranged (not shown). Through such an embodiment, the mixing length in the mixing chamber 2 can be substantially extended.

In alternative variants thereto of the example, the distance d₁ between the exhaust line 3 and the charge-air cooler 15 can be greater (not shown) or, as illustrated in FIG. 1a, smaller than the distance d₂ between the exhaust line 3 and said second housing wall 13. According to the design, a multiplication, e.g. doubling or tripling, of the mixing length can thus be achieved.

In the example of FIG. 1a, the four exhaust gas outlet openings 5 form the exhaust gas outlet 7. Of course, the number of four exhaust gas outlet openings 5 shown in FIG. 1a is to be regarded as purely by way of example. Preferably, a number of exhaust outlet openings 5 is provided, which is greater than the number of cylinders of the internal combustion engine using the induction module 1. Preferably, the number of exhaust gas outlet openings 5 is a multiple of the cylinder number or more. For example, the use of eight, but also of 16 exhaust gas outlet openings 5 is conceivable, when the induction module 1 is used in an internal combustion engine with four cylinders. Alternatively, however, also any desired number of exhaust gas outlet openings 5, not associated individually to the individual cylinders, can be provided.

With regard to the geometric configuration of the exhaust gas outlet openings 5 themselves, various structural options present themselves to the specialist, which are shown by way of example in the rough diagrammatic illustration of FIG. 4. Exhaust gas outlet openings 5, which have for instance a round, in particular circular, or an elliptical opening contour are technically particularly simple to realize, cf. in this respect FIG. 4b. Alternatively, a realization, shown in FIG. 4c, with a polygonal opening contour, thus for example a rectangular and here in particular a square opening contour, is to be recommended. Also, a combination, sketched in FIG. 4a, of a rectangular and a semicircle is conceivable.

For the purpose of a cost-efficient manufacture of the induction module 1 according to the invention, the charge-air cooler 15 and exhaust line 3 can be formed integrally on the housing 8 of the mixing chamber 3. Alternatively thereto, the charge-air cooler 15 and exhaust line 3 can, however, also be screwed or welded to the housing 8.

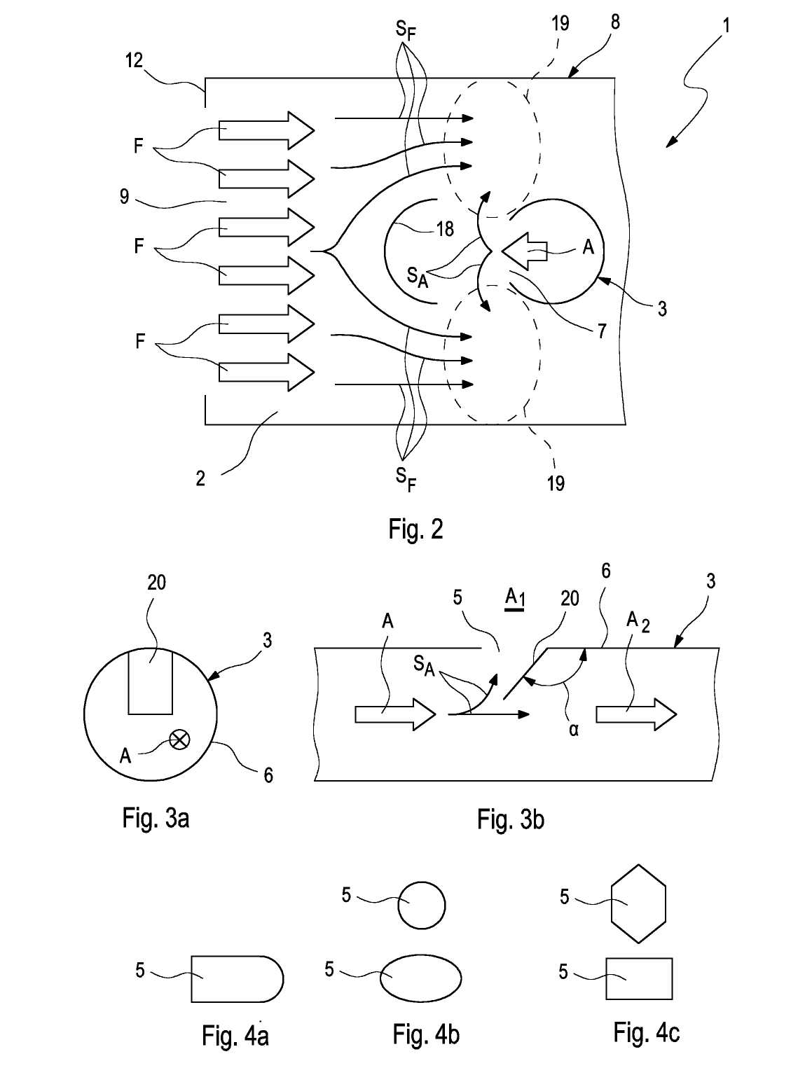

In FIG. 1b an alternative embodiment of the induction module 1′ of FIG. 1a is illustrated. This example embodiment corresponds substantially to the induction module 1 explained in FIG. 1a. Therefore, all the embodiments belonging to FIG. 1a, in particular those of FIGS. 2 to 4, can be transferred mutatis mutandis to the induction module 1′. In contrast to FIG. 1a, the aperture 10 in the variant of FIG. 1b is not arranged in the lateral region of the housing 8, but in an upper or respectively lower region of the housing 8. Therefore, the exhaust gas A is not conducted in laterally into the housing interior 4, whereby very different flow lengths in the exhaust line 3 are produced, but over a central region. Through this type of conducting in, the flow lengths in the exhaust line 3 shorten, whereby more uniform pressure conditions occur and thus a more uniform conducting in of the exhaust gas is produced.

In order to further improve the mixing of fresh air F and exhaust gas A explained above, the arrangement of a deflection element 18 in the mixing chamber 2, illustrated diagrammatically in FIG. 2, is recommended, and namely in flow direction S_{F} of the fresh air F between air inlet 9 and exhaust line 3, cf. in this respect FIG. 1. The placing of such a deflection element 18, for example in the manner of a shield, takes place such that it deflects at least a portion of the fresh air F introduced into the mixing chamber 3, before said fresh air meets the exhaust gas A.

The deflection element 18 shown in FIG. 2 in cross-section has the shape of a segment of a circle and brings about a deflection of the exhaust gas A introduced into the mixing chamber 2. Here, the fresh air F is channeled towards edge regions of the housing 8. Consequently, fresh air F and exhaust gas A indeed have opposite flow directions S_{F}, S_{A} on conducting in into the mixing chamber 2, owing to the deflecting characteristics of the element 18, but not, however, at the actual meeting in the mixing chamber 2 in the region designated by 19 in FIG. 2.

According to the cross-section of the mixing chamber 3 shown in FIG. 2, the deflection element 18 can generally have a geometry curved, for example in the manner of a segment of a circle, towards the exhaust gas outlet 7. The formation of eddy flows which can reduce the air- or respectively exhaust gas mass throughput through the induction module 1 in an undesired manner, is largely prevented in this way.

Alternatively or additionally to the deflection element 18 shown in FIG. 2, for instance for the case where several exhaust gas outlet openings 5 are provided in the exhaust line 3, at at least one exhaust gas outlet opening 5 an exhaust gas deflection element 20 can be provided, projecting inwards into the exhaust line 3. This is shown in FIG. 3 both in a rough diagrammatic manner and also by way of example for a single such outlet opening 5, wherein FIGS. 3a and 3b show the exhaust line 3 in a transverse or respectively longitudinal section. Such an exhaust gas deflection element 20 is able to assist the conducting out of a portion A₁ of the exhaust gas A flowing through the exhaust line, whereas the portion of the exhaust gas A₂, complementary to the partial amount A₁, remains in the exhaust line 3. In this way, a little effective accumulation of exhaust gas A at the axial end of the exhaust line 3 is largely or even completely prevented.

According to the example of FIG. 3b, the exhaust gas deflection element 20 can form in the cross-section of the mixing chamber 3 an angle α of substantially 135° with a circumferential wall 6 of the exhaust line 3. Of course, other values for the angle α can also be realized through uncomplicated structural alterations.

1. An induction module with integrated exhaust gas recirculation, comprising:
a housing defining a housing interior and having a first housing wall with at least one air inlet for conducting fresh air into the housing interior and a second housing wall with at least one fluid outlet,
a charge-air cooler arranged in the housing interior,
a mixing chamber defining at least part of the housing interior and delimited by the charge-air cooler and the second housing wall,
an exhaust line arranged in the mixing chamber and having at least one exhaust gas outlet which fluidically communicates with the mixing chamber, the at least one exhaust gas outlet configured to communicate an exhaust gas flowing through the exhaust line into the mixing chamber,
wherein the at least one exhaust gas outlet is disposed on a side of the exhaust line facing toward the at least one air inlet of the first housing wall, and
wherein the charge-air cooler and the exhaust line are arranged in the housing such that the exhaust gas communicated into the mixing chamber bypasses the charge-air cooler.

2. The induction module according to claim 1, wherein the charge-air cooler and the exhaust line are arranged in the housing such that a flow direction of the exhaust gas communicated into the mixing chamber traverses substantially opposed to a flow direction of the fresh air communicated into the mixing chamber, so that the flow directions of the exhaust gas and the flow direction of the fresh air form an angle of substantially 180° to one another.

3. (canceled)

4. The induction module according to claim 1, wherein a distance between the exhaust line and the charge-air cooler is substantially equal to another distance between the exhaust line and the second housing wall.

5. The induction module according to claim 1, wherein the charge-air cooler is configured as a tube bundle cooler or a rib-tube cooler, and wherein the charge-air cooler includes at least one coolant path having a coolant inlet and a coolant outlet on a face-side housing wall, and the charge-air cooler is arranged substantially parallel to the exhaust line in the housing interior with respect to the coolant path.

6. The induction module according to claim 1, wherein at least one of:
the charge-air cooler includes a cooler housing composed of a metal, and
the housing of the induction module is composed of a plastic.

7. The induction module according to claim 6, wherein the cooler housing has a housing wall facing toward the exhaust line, the housing wall having at least one charge-air inlet for conducting the fresh air, which is at least partially cooled in the charge-air cooler, into the mixing chamber.

8. The induction module according to claim 1, wherein at least one of the charge-air cooler and the exhaust line are formed integrally on the housing.

9. The induction module according to claim 1, wherein the housing further includes an aperture, and wherein the exhaust line is received in the aperture from the exterior into the mixing chamber.

10. The induction module according to claim 1, wherein the second housing wall includes at least two fluid outlets for discharging the fresh air mixed with the exhaust gas in the mixing chamber.

11. The induction module according to claim 1, wherein the exhaust gas outlet includes a plurality of exhaust gas outlet openings.

12. The induction module according to claim 1, further comprising at least one deflection element disposed between the charge-air cooler and the exhaust line, the at least one deflection element configured to deflect at least a portion of the fresh air communicated into the mixing chamber, before the fresh air mixes with the exhaust gas communicated into the mixing chamber.

13. The induction module according to claim 12, wherein:
the at least one air inlet and the exhaust gas outlet face toward one another in a cross-section of the mixing chamber, and
the at least one deflection element has in the cross-section of the mixing chamber a geometry curved toward the exhaust gas outlet.

14. The induction module according to claim 12, wherein the exhaust gas outlet has at least one exhaust gas outlet opening, and wherein the at least one exhaust gas outlet opening includes an exhaust gas deflection element projecting inwards into the exhaust line, the exhaust gas deflection element configured to at least partially deflect the exhaust gas flowing through the exhaust line.

15. The induction module according to claim 13, wherein the geometry of the at least one deflection element is configured as a circle segment.

16. The induction module according to claim 1, wherein a distance between the exhaust line and the charge-air cooler is smaller than another distance between the exhaust line and the second housing wall.

17. The induction module according to claim 1, wherein a distance between the exhaust line and the charge-air cooler is greater than another distance between the exhaust line and the second housing wall.

18. The induction module according to claim 1, wherein the at least one air inlet and the exhaust gas outlet face toward one another in a cross-section of the mixing chamber.

19. The induction module according to claim 1, wherein the exhaust gas outlet has at least one exhaust gas outlet opening, and wherein the at least one exhaust gas outlet opening includes an exhaust gas deflection element projecting inwards into the exhaust line, the exhaust gas deflection element configured to at least partially deflect the exhaust gas flowing through the exhaust line.

20. The induction module according to claim 2, wherein a distance between the exhaust line and the charge-air cooler is one of equal to, smaller than and greater than another distance between the exhaust line and the second housing wall.

21. The induction module according to claim 5, wherein the charge-air cooler further includes a cooler housing composed of a metal.
